(19) United States
(12) Patent Application Publication
(10) Pub. No.: US 2010/0079908 A1
(43) Pub. Date: Apr. 1, 2010

(54) Determining A Magnetic Sample Characteristic Using A Magnetic Field From A Domain Wall

(75) Inventor: Juergen Heidmann, Salinas, CA (US)

Correspondence Address: Silicon Valley Patent Group LLP, 18805 Cox Avenue, Suite 220, Saratoga, CA, 95070, US

(73) Assignee: Infinitum Solutions, Inc., Santa Clara, CA (US)

(21) Appl. No.: 12/240,770

(22) Filed: Sep. 29, 2008

(51) Int. Cl. G11B 5/127

(52) U.S. Cl. 360/110; G9B/5.04

(57) ABSTRACT

A magnetic field generator that is formed from a magnetic thin film, e.g., of ferrimagnetic garnet with a two magnetic domains with a domain wall between the two magnetic domains, is provided. A localized magnetic field is produced by the domain wall and is used as a magnetic field source for a sample held on or near the surface of the magnetic thin film. The sample response to the magnetic field is measured for one or more positions of the domain wall with respect to the sample. From the measured response, a desired parameter may be determined and stored. The position of the domain wall may be oscillated at high frequency to produce a voltage signal in the inductive sample. Alternatively, distortions in the domain wall may be imaged and used to identify or characterize structures in the sample.

### FIELD OF THE INVENTION

The present invention is related to a nanometer sized movable magnetic field source, and, in particular, to generating and using the movable magnetic field source to determine parameters of a sample.

### BACKGROUND

As technology advances, devices continue to shrink in size, and it becomes increasingly difficult to test or verify the operation of the devices. One example of this is found in storage systems based on magnetic recording technology, which is commonly used in devices such as computers and digital electrical household appliances. In operation, a magnetic write head is used to magnetize bits of data on the recording medium, commonly referred to as a hard disk, while a read sensor is used to read the bits of data from the hard disk.

It is desirable to test devices, such as read sensors and write heads, early in the manufacturing process to increase yield and reduce costs. However, as devices, such as the read sensors and write heads, continue to shrink in size it is increasingly difficult to perform accurate measurements early in the manufacturing process. For example, a read sensor is sometimes characterized using a spinstand tester that emulates the actual Hard Disk Drive (HDD) operation. Spinstand testers, however, are expensive and time consuming to use. Another type of tester that may be used is a scanning electron microscope (SEM), however, SEMs require cross-sectioning of the devices under test and are therefore destructive. A force modulation microscope (FMM) may also be used to test small devices. These instruments are not suitable for production, however, as it is time consuming to properly align and the devices are detrimental, as a stylus is dragged across the sample.

Accordingly, a different measurement device that is non-destructive and that can be used to test, verify, or otherwise work with small devices is desired.

### SUMMARY

In accordance with one embodiment, a magnetic field generator is formed from a magnetic thin film, e.g., of ferrimagnetic garnet, with two magnetic domains with a domain wall between the two magnetic domains. By way of example, one of the two domains may be in the form of a stripe or bubble. If additional domains are present, the domains may be in the form of stripes, e.g., arranged in parallel or otherwise, as well as bubbles including a hexagonal bubble lattice. A sample is held on or near enough to the surface of the film to be effected by the magnetic field from the domain wall. The sample response to the localized magnetic field from the domain wall is measured for one or more positions of the domain wall with respect to the sample. From the measured response a desired parameter may be determined and stored. The position of the domain wall may be oscillated to simulate a rotating magnetic disk or to produce a voltage signal in an inductive sample, such as a write head.

In accordance with another embodiment, an apparatus includes a magnetic field generator with a surface. The magnetic field generator includes a magnetic thin film, e.g., of ferrimagnetic garnet, in which there are two magnetic domains with a domain wall between the two magnetic domains, where a magnetic field is produced by the domain wall. A second magnetic field generator is positioned relative to the first magnetic field generator so that a variation in a magnetic field produced by the second magnetic field generator can change the position of the domain wall and, thus, the location of the magnetic field produced by the domain wall. A probe that is configured to be electrically coupled to a sample while the sample is held on or near the surface of the first magnetic field generator is also provided. Additionally, a processor may be included that is coupled to the second magnetic field generator and the probe, where the processor controls the second magnetic field generator and receives signals from the probe to determine desired parameters of the sample. The domain wall generates both in-plane and perpendicular fields, and, thus, the magnetic samples that are sensitive to either perpendicular or in-plane fields may be measured.

In accordance with another embodiment, a ferrimagnetic garnet film is initialized to produce parallel, straight domain walls by applying an in-plane magnetic field to the garnet film and applying a perpendicular magnetic field to saturate the garnet film. The perpendicular magnetic field is reduced until domains in the garnet film nucleate and produce parallel domain walls between the magnetic domains. If desired, the perpendicular magnetic field may then be further reduced to extend the length of the parallel domain walls and the in-plane magnetic field may be removed.

In another embodiment, a sample is held on or close to the surface of a magnetic field generator that comprises a magnetic thin film in which there are two magnetic domains with a domain wall between the magnetic domains, wherein a magnetic field is produced by the domain wall. The sample is microactuated to move either a part of the sample, e.g., a read sensor or write head, or the entire sample, with respect to the domain wall. Signals from the sample are then detected from the sample in response to the magnetic field. Using the detected signals, a parameter of the sample, such as the performance of the microactuator may be determined and stored.

In another embodiment, a sample is held on or near the surface of a magnetic field generator that comprises a magnetic thin film in which there are two magnetic domains with a domain wall between the domains, wherein a magnetic field is produced by the domain wall. The position of the domain wall is changed with respect to the sample and the moving domain wall is magneto-optically imaged, e.g., using Faraday or Kerr domain imaging. By monitoring the location of distortions in the images of the moving domain wall, structures in the sample can be characterized and stored. In one embodiment, the structures are characterised by determining the location of the structures, which may be defects in the sample. In another embodiment, the structures are characterized by determining the shape of the structures.

### BRIEF DESCRIPTION OF THE DRAWINGS

FIG. 1A illustrates a device with a small, e.g., nanometer sized, movable magnetic field source formed from domain walls that may be used, e.g., for testing a sample such as a read sensor or write element.

FIG. 1B illustrates a top plan view of a portion of a garnet film with domain walls that produce a magnetic field.

FIG. 2 illustrates the width of a domain wall in a top plan view of a portion of a garnet film.

FIG. 3 illustrates a Faraday domain image of a remanent state for a garnet film with perpendicular magnetization.

FIGS. 4 and 5 illustrate Faraday domain images of a large number of parallel stripe domains in a garnet film.

FIG. 6 illustrates a flow chart of the process of initializing a garnet film to produce a parallel stripe-domain array as illustrated in FIG. 5.

FIG. 7A illustrates a cross-sectional view of a garnet film with integrated domain array stabilization.

FIG. 7B illustrates a top plan view of a patterned garnet film.

FIGS. 8A and 8B illustrate a Faraday domain image of an array of domains generated by applying a localized RF-field and an apparatus for rotating the field gradient, respectively.

FIGS. 9A, 9B, and 9C illustrate a top plan view of a portion of the garnet film, a graph illustrating the domain wall profile and a graph illustrating the stray field from the domain wall, respectively.

FIGS. 10A and 10B illustrate top plan views of a magnetic recording head placed on the surface of the garnet film and the domain walls moving with respect to the magnetic recording head 120 due to the application of an external magnetic field.

FIG. 11 illustrates a graph of the domain wall profile, similar to that shown in FIG. 9B, except with a schematic illustration of a read sensor positioned over and scaled with respect to the graph.

FIG. 12 illustrates a perspective view of a portion of the garnet film with three adjacent domains and two domain walls separated by a distance w.

FIG. 13 is a graph illustrating the relationship between the width w(microns) and the external magnetic field H(Oe).

FIGS. 14A and 14B are graphs illustrating measured domain widths with respect to an applied perpendicular magnetic field.

FIG. 15 is a graph illustrating the domain wall displacement for an externally applied perpendicular magnetic field that varies between ±6 Oe.

FIG. 16 is a flow chart illustrating a process of using the garnet film as a movable magnetic field source to determine a parameter of a sample.

FIG. 17 is a graph illustrating along the vertical and horizontal axes a measured sensor response and the x-coordinate (cross-track direction) of the sample, respectively.

FIG. 18 schematically illustrates the circuitry that may be used to excite and measure a sample, such as an inductive device, using an AM modulated excitation-field.

FIG. 19 is a graph illustrating an AM modulated excitation-field waveform that may be produced by the circuitry shown in FIG. 18 and used to excite a domain wall for the measurement of the response from a sample, such as an inductive device.

FIG. 20 illustrates a graph showing the amplitude of a writer signal and an x-coordinate position of a domain wall with respect to a writer, as well as two images of the domain wall and a writer element taken at the occurrence of the peak signals.

FIG. 21 is a graph similar to that shown in FIG. 20, illustrating the sensitivity of the signal to the domain wall moving from the leading edge to the trailing edge of a return pole of a writer element.

FIG. 22 is a graph similar to FIG. 21, with the x axis is labeled DC field control, which shows the lock-in signal during a cross-track scan of the domain wall over a writer.

FIG. 23 illustrates an embodiment in which a magnetic recording head is held by a suspension near the surface of the garnet film and moved using a microactuator.

FIG. 24 illustrates a perspective view of a garnet film with domains and a domain wall between the domains and a vertical Bloch-line.

FIG. 25A illustrates a top plan view of a garnet film with an integrated magnetic field generator with a bubble domain.

FIG. 25B illustrates a top plan view of a garnet film with an integrated magnetic field generator with a stripe domain.

FIG. 26 illustrates the domain confinement and positioning of a domain using the integrated magnetic field generator illustrated in FIGS. 25A and 25B.

### DETAILED DESCRIPTION

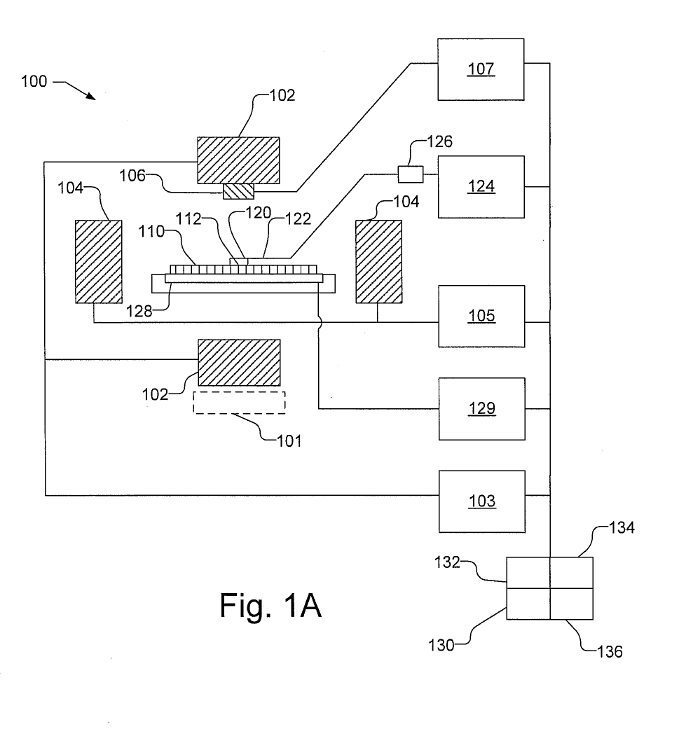

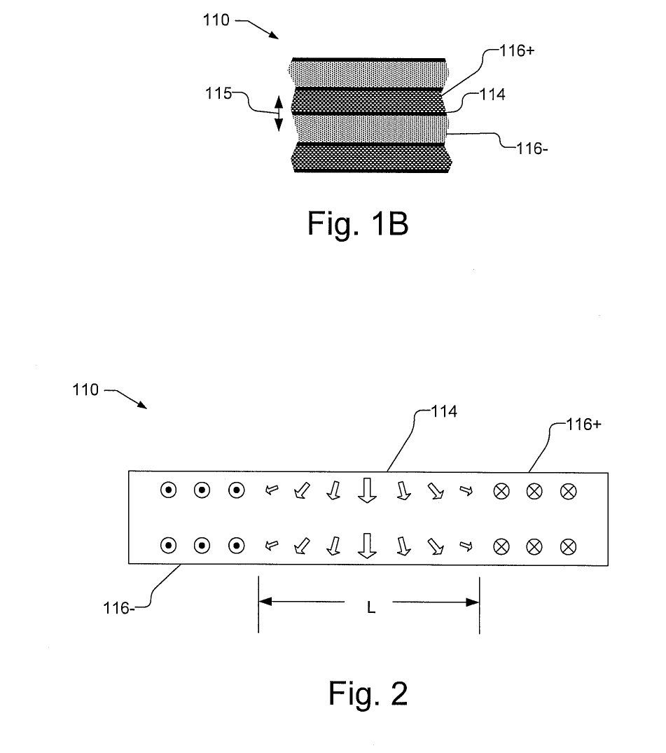

FIG. 1A illustrates a device 100 that uses a magnetic field generator 112 to produce a small, e.g., nanometer sized, movable magnetic field that may be used as a probe for a sample 120 under test. The device 100 is illustrated as being configured for testing a magnetic recording head 120, which includes both, a read sensor and an inductive write head, but the device 100 can be used with other magnetic field sensors or other devices, including Tape Heads.

The magnetic field generator 112 produces a magnetic field from a domain wall in the form of a stray magnetic field. The magnetic field generator 112 may use, e.g., a ferrimagnetic garnet film 110. Films, other than ferrimagnetic garnet films, that produce domain walls may be used with device 100 if desired. For example, if desired, materials such as NiFe, CoFe, or CoNiFe alloys or single crystals made from these elements may be used in place of ferrimagnetic garnet. For the sake of simplicity, the film 110 will sometimes be referred to as garnet film 110, but it should be understood that the film 110 is not limited to garnet.

The garnet film 110 may have a perpendicular, in-plane, or canted magnetization orientation and may have a uniaxial-anisotropy or orthorhombic-anisotropy. The garnet film may have a Faraday rotation coefficient that is 2.1 degree per one micron of thickness of garnet film at wavelength 633 nm, the saturation perpendicular magnetic field is 93 Oe. In one embodiment, the ferrimagnetic garnet film has an additional axis of easy magnetization in the film plane. A suitable garnet film may be polycrystalline or monocrystalline and deposited over a non-magnetic garnet substrate, such as a Gallium-Gadolinium-garnet, e.g., by liquid phase epitaxi, and may have formed from various compositions and a thickness range of, e.g., 0.1 μm to 30 μm. By way of example, one suitable film is a monocrystalline garnet film having a composition of (Bi,Y,Pr)_{3.0}(Fe,Ga)_{5.0}O_{12.0}, and a thickness of 6.5 microns, however, other compositions and thicknesses may be used if desired. In one embodiment, suitable films may be defined by the anisotropy and saturation magnetization 4πMₛ. For example, to produce narrow domain walls, e.g., 10 nm, a garnet film with a perpendicular anisotropy between 4000 Oe to 8000 Oe, and more particularly 5000 Oe, may be used. The saturation magnetization 4πMₛ is application specific, but in some applications, such as testing magnetic recording heads, it may be desirable for the saturation magnetization 4πMₛ to be as high as possible, e.g., 255 Oe or greater. The stripe width, i.e., the width of the domain in zero field may be, e.g., 9 μm. It should be understood that a wide range of compositions of the garnet film may be used to provide a desired anisotropy and saturation magnetization for a desired particular application.

FIG. 1B illustrates a top plan view of a portion of the garnet film 110, e.g., the portion under the magnetic recording head 120 in FIG. 1A. As can be seen in FIG. 1B, between domains 116+ and 116− (collectively domains 116) in the film 110 is a domain wall 114, which produces a magnetic field. Adjacent domains 116 have opposite magnetization directions, and the domain wall 114 between the domains 116 has a transitional magnetization orientation with a component that is perpendicular to the magnetization orientations of the domains 116. The position of the domain wall 114 and, thus, the location of its magnetic field may be altered, e.g., using a perpendicular magnetic field source 102 and/or magnetic field source 106. In some embodiments, the domains 116 may be initialized and stabilized by a combination of perpendicular magnetic fields and in-plane magnetic fields created by magnetic field sources 102 and 104, respectively, shown in FIG. 1A. In other embodiments, initialization and stabilization of the domains in the film 110 is not necessary, e.g., when the domain walls may self-align with a sample, such as a recording head, or alternatively when the use of non-parallel striped domains, illustrated in FIG. 3 below, is acceptable. With the need for initialization and stabilization eliminated, the in-plane magnetic field generator 104 may be eliminated.

The device 100 may include a perpendicular magnetic field source 102 and an in-plane magnetic field source 104, which may be, e.g., air coils and/or iron cores. The perpendicular magnetic field source 102 and in-plane magnetic field source 104 produce magnetic fields that respectively have a normal component and a perpendicular component with respect to the surface of the garnet film 110. While the perpendicular magnetic field source 102 is illustrated as including two coils, e.g., one on the an upper side of the garnet film 110 and the other on the lower side, if desired, only one coil may be used, e.g., on the upper side of the garnet film 110. The use of one coil for the magnetic field source 102 may permit the use of a magneto-optical imaging device 101 may be positioned on the opposite side of the garnet film 110. Alternatively, the magneto-optical imaging device may be used with the two magnetic field sources 102, e.g., by placing the microscope lens through a center hole of a coil 102. Further, if desired, only a single coil may be used for the magnetic field source 104 instead of the two illustrated. The position of the domain wall 114 is controlled by the magnetic field source 102, but if an in-plane magnetic thin film is used, e.g., a garnet film with in-plane magnetization, the in-plane magnetic field source 104 may be used to control the domain wall position. The perpendicular magnetic field source 102 is controlled by a perpendicular field controller 103 and the in-plane magnetic field source 104 is controlled by an in-plane field controller 105, both of which may be coupled to a central processor 130. The precise location and movement of the domain wall 114, as illustrated by arrow 115 in FIG. 1B, may be controlled via magnetic field source 102 with nanometer accuracy. Additionally, a second perpendicular magnetic field source 106, which may be a high frequency coil 106 that is controlled by controller 107, may be used in addition to field source 102 to drive the position of domain wall 114 and, if desired, to excite the domain wall 114 at a high frequency, e.g., in kHz or MHz ranges. If desired, two high frequency coils 106, one on the upper side and one on the lower side of the garnet film 110 may be used. In one embodiment, there is approximately 4 mm between the bottom surface of coils 106 (or magnetic field source 102 if coil 106 is not used) and the top surface of the garnet film 110. The controllers 103, 105, and 107 may be, e.g., power supplies, and may include circuitry, such as frequency generators, to control the magnitude of the magnetic field produced by the respective magnetic field generators 102, 104, and 106 as well as the frequency if an AC magnetic field is produced. In some embodiments, the controllers 103, 105, and 107 may receive signals from the processor 130 or, e.g., other components, such as an intermediary frequency generator, and control the magnitude (and frequency) of the magnetic fields produced by the respective magnetic field generators 102, 104, and 106 in response thereto.

For testing a state of the art read sensor with a 100 nm cross-track dimension, using a garnet film 110 as discussed above, with a domain wall width of 11 nm as discussed in reference to FIG. 2 below, the device 100 may include a controller 103 for the perpendicular magnetic field source 102 that is a high stability, low noise current source that produces a magnetic field of, e.g., 200 Oe, that may be varied by e.g., ±80 Oe. The movement of the domain wall 114 can be achieved using the magnetic field source 106 with a controller 107 that is also a low noise, high stability current source that produces a magnetic field of ±6 Oe with a resolution of 0.1 Oe to displace the domain wall 114 by approximately one width, i.e., 10 nm. Moreover, the controller 107 may have a bandwidth of up to 10 MHz or higher as necessary for testing inductive devices. For some applications, the coil 106 is not required if the precision of the controller 103 and field source 102 is sufficient to achieve the desired control of the domain wall 114. The maximum field for the in-plane magnetic field source 104 is, e.g., 250 Oe. It should be understood that materials other than garnet for the film 110 or different precisions will require other requirements for the field sources.

As illustrated in FIG. 1A, the magnetic recording head 120 is held in contact with the film 110 and may be held stationary while the location of the domain wall 114 is moved with respect to the magnetic recording head 120. The read sensor of the magnetic recording head 120 is coupled to a probe 122 that is coupled to an oscilloscope or a digitizer 124 through a read amplifier 126. The oscilloscope or digitizer 124 is connected to the processor 130, which receives and analyzes the data provided by the oscilloscope or digitizer 124. The processor 130 includes a computer-usable medium 132 having computer-readable program code embodied therein for causing the processor 130 to control the tester including the magnetic field sources 102 and 104 and to perform a desired analysis, as described herein. If desired, multiple separate processing units may be used to perform discrete tasks, such as analysis of the received data and controlling the magnetic field generators via the controllers. In such an embodiment, the discrete processing units may be coupled together or may be separated. However, it is generally desirable for the processing unit that is analyzing the data to also receive data indicating the position of the domain wall 114 (or equivalently, the magnitude of the magnetic field provided by the perpendicular magnetic field generator 102 and/or 106). In such an embodiment, the several discrete processing units are considered herein as a single processor 130.

The data structures and software code for automatically implementing one or more acts described in this detailed description can be implemented by one of ordinary skill in the art in light of the present disclosure and stored on a computer readable storage medium, which may be any device or medium that can store code and/or data for use by a computer system such as processor 130. This includes, but is not limited to, magnetic and optical storage devices such as disk drives, magnetic tape, compact discs, and DVDs (digital versatile discs or digital video discs). The processor 130 includes storage/memory 134 and a display 136 for storing and/or displaying the results of the analysis of the data.

FIG. 2 illustrates the width L of the domain wall 114 in a top plan view of a portion of the garnet film 110. The magnetization in the domains 116+ and 116− on either side of the domain wall 114 are represented by arrows into and out of the page. The domain wall width L, which determines the stray-field distribution, is determined by the exchange constant A and the uniaxial anisotropy energy density Kᵤ. For a garnet film with the above-described specifications, the width L is determined as follows:

$$\begin{matrix}A = 1.8 \cdot {10}^{- 7} erg \text{/} cm & eq . 1 \\ {K}_{u} = 1.4 \cdot {10}^{6} erg \text{/} {cm}^{3} & eq . 2 \\ L = π \sqrt{\frac{A}{{K}_{u}}} = 11 nm & eq . 3\end{matrix}$$

A wall width L of 11 nm is sufficient to resolve the magnetic write width of a typical 120 nm read sensor or write head in a magnetic recording head 120. To achieve narrower domain walls and consequently a narrower field distribution, the uniaxial anisotropy energy density Kᵤ can be increased.

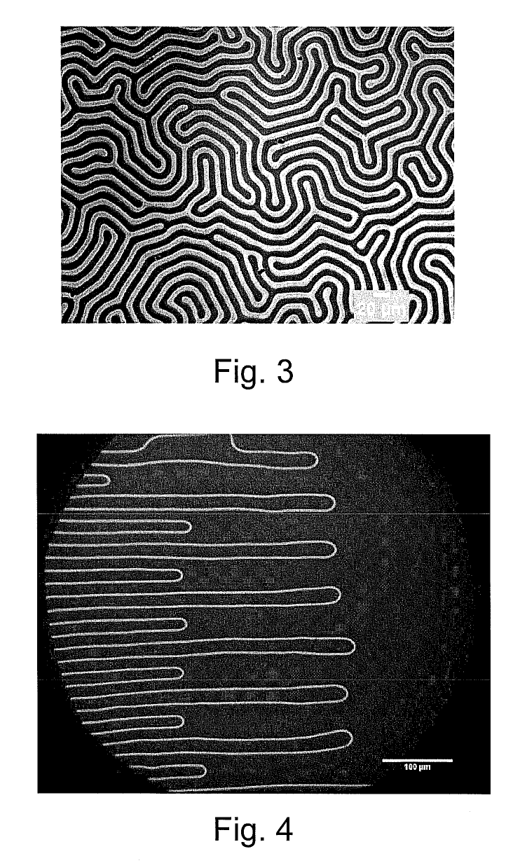

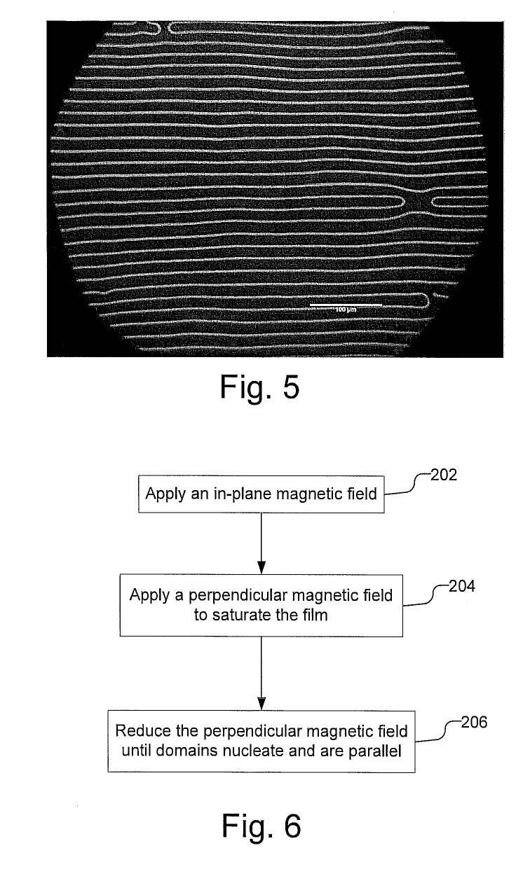

FIG. 3 illustrates a Faraday domain image of a remanent state for a garnet film with perpendicular magnetization, where the domains are the light and dark regions of the image and the domain wall is at the transition between the domains. The garnet film of FIG. 3 may be used as the magnetic field generator 112 to produce the desired movable magnetic field probe. The domains illustrated in FIG. 3 are considered herein to be stripe domains. If desired, an array of stripe domains that are parallel arranged may be created, as illustrated in the Faraday domain image of FIGS. 4 and 5, by applying a suitable sequence of in-plane and perpendicular magnetic fields using magnetic field sources 102 and 104 shown in FIG. 1A. As illustrated in FIGS. 4 and 5, an array of parallel arranged stripe domains may be used as the measurement site for the magnetic recording head 120. In other words, the read sensor of the magnetic recording head 120 may be positioned on the garnet film 110 above the parallel arranged stripe domains. It should be understood that the array of the domains need not be uniform for many applications.

In some embodiments, the domain wall 114 of the garnet film 110 may be self-aligning with the sample under test, e.g., a recording head 120. For example, the hard bias magnetic structures of the recording head may repeatedly guide the domain wall 114 to a desired initial location in the cross-track direction. Thus, perpendicular magnetic field source 102 and/or 106 may produce a magnetic field of, e.g., 40 Oe to 46 Oe, and the sample 120 may be placed on the surface of the garnet film 110 and the domain wall 114 will self-align. The domain wall 114 may then be displaced by varying the magnetic field produced by the perpendicular magnetic field source 102 and/or 106.

In another embodiment, a large number of parallel stripe domains in the garnet film 110, as illustrated in the Faraday domain images of FIGS. 4 and 5, may be produced through appropriate manipulation of the perpendicular and in-plane magnetic fields. The sample 120 may then be placed on the surface of the garnet film 110. For example, to produce parallel stripe domains, an in-plane field may be applied by the field source 104 to the garnet film 110 while the film 110 is saturated by a perpendicular field produced by the field source 102. The perpendicular field may be subsequently reduced until domains in the garnet film 110 nucleate. Micromagnetic energy considerations, such as reduction of Zeeman energy of the domain wall, suggest that the domains expand along the external in-plane field direction. Moreover, this effect is isotropic in the plane of the garnet film 110. Alternatively a garnet film with an in-plane anisotropy could be used.

A process of initializing the garnet film 110 to produce a parallel stripe-domain array such as that shown in FIG. 5, is illustrated in FIG. 6. With the garnet film 110 positioned in a two-axis magnetic field source, e.g., field sources 102 and 104, an in-plane magnetic field is applied along one axis by the magnetic field source 104 to the garnet film 110 (block 202). The initial in-plane magnetic field is a large field, e.g., 200 Oe or the maximum field achievable. A perpendicular magnetic field is then applied along the other axis by the magnetic field source 102 to saturate the garnet film 110 (block 204). By way of example, a magnetic field of 140 Oe may be sufficient to saturate the garnet film 110. The perpendicular magnetic field may then be reduced until the domains nucleate at about 85 Oe and expand to be parallel for a desired length, which is illustrated in FIG. 5 (block 206). If desired, the in-plane magnetic field and perpendicular magnetic field may be alternatively reduced to further extend the length of the parallel domains until the in-plane magnetic field is removed. Additionally, if desired, instead of a single axis magnetic field source 104, a dual axis magnetic field source, e.g., magnetic field source 104 combined with an additional orthogonal in-plane magnetic field source, may be used to produce a stripe orientation at a desired angle.

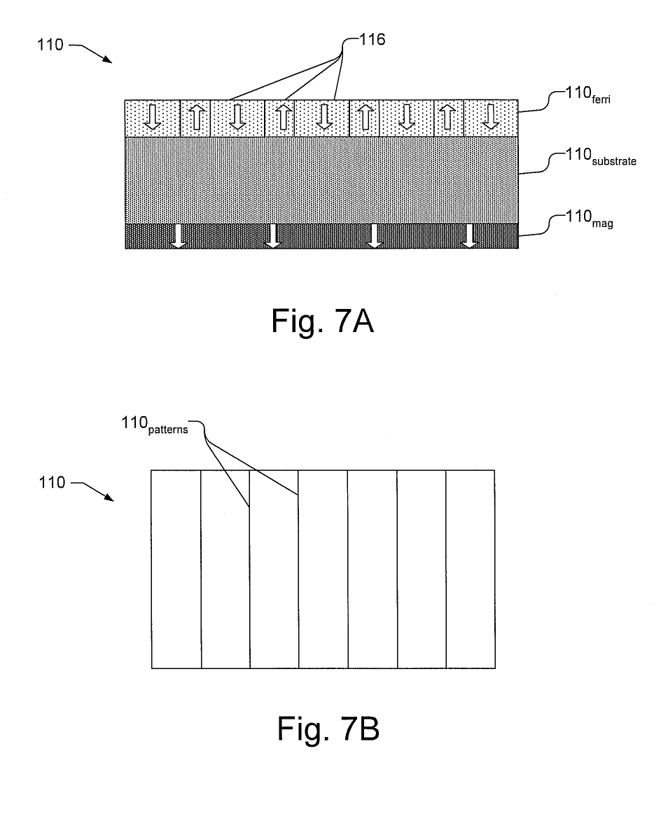

As an alternative, an array of parallel arranged stripe domains may be produced in a garnet film 110 possessing an in-plane magnetic anisotropy with or without external fields. FIG. 7A illustrates a cross-sectional view of a garnet film 110 with integrated domain array stabilization. The garnet film 110 includes a non-magnetic garnet substrate 110_{substrate} with a ferrimagnetic garnet film 110_{ferri} on the top surface and a hard magnetic film 110_{mag} deposited on the bottom surface. The hard magnetic film 110_{mag} produces a perpendicular magnetic field with respect to the ferrimagnetic film 110_{ferri}, which results in a stable array of domains 116, as illustrated in FIG. 7A. With a garnet film 110 with integrated domain array stabilization and with a sufficiently high in-plane anisotropy, the in-plane magnetic field generator 104 of FIG. 1A may be obviated.

FIG. 7B illustrates a top plan view of another embodiment of the garnet film 110 in which a series of patterns 110ₚₐₜₜₑᵣₙₛ are etched, scratched, or otherwise produced in the garnet film 110. The patterns 110ₚₐₜₜₑᵣₙₛ may be used to produce multiple areas on the garnet film 110 with parallel stripe domains, and thus, multiple areas of parallel domain walls, which may be advantageous when multiple read sensors or write heads are measured in bar form. With the use of a film 110 with constraints such as patterns 110ₚₐₜₜₑᵣₙₛ shown in FIG. 7B, there may be little or no need for the in-plane magnetic field generator 104.

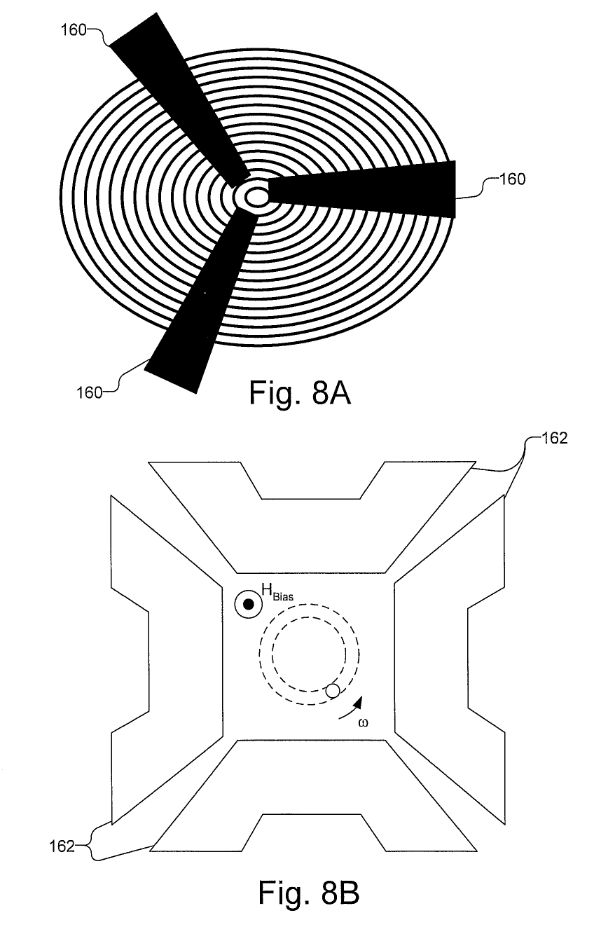

In another embodiment, as illustrated in FIGS. 8A and 8B, a regular array of domains can also be generated by applying a localized RF-field to the garnet film 110. The RF-field is generated by a microscopic thin film antenna structure 160. While the RF-field is on, concentric circular domains will form when the perpendicular field is reduced from near saturation to zero. The circular domain structure will create a stable remanent state even when the RF-field is turned off. Because the radius of the circular domains is orders of magnitude larger than the sensor/writer dimension, the circular domain wall is equivalent to that of a stripe domain.

Moreover, rather than moving a domain wall separating two stripe domains, a single cylindrical domain, sometimes known as a magnetic bubble, can be continuously moved in a rotating field gradient on a circular trajectory. When a magnetic sensor is positioned in the trajectory of the domain, the sensor will respond when the domain wall passes by. Because the linear velocity of the domain is precisely known, the sensor dimension can be calculated from the time response of the sensor. The rotating field gradient may be created by four small conductors 162, as illustrated in FIG. 8B.

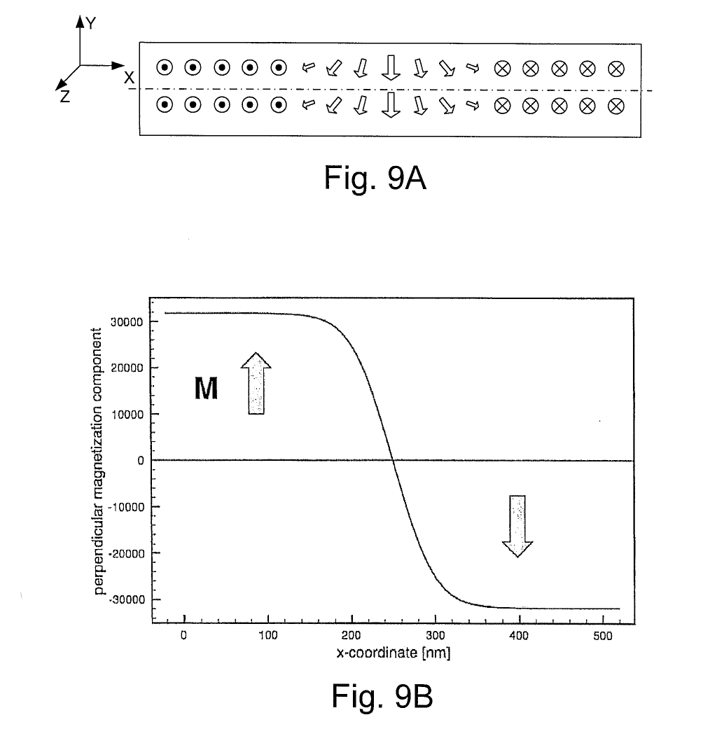

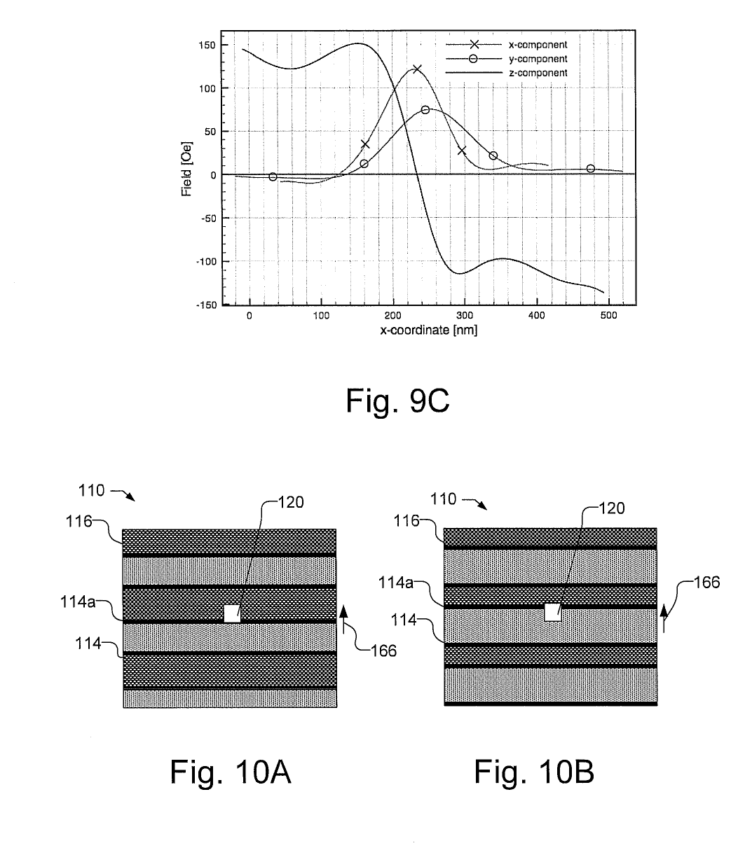

FIGS. 9A, 9B, and 9C respectively illustrate a top plan view of a portion of the garnet film 110, a graph illustrating the domain wall profile and a graph illustrating the stray field from the domain wall. The horizontal axis of the graph in FIG. 9B represents the x-coordinate of the garnet film 110 in nanometers and the vertical axis represents the perpendicular magnetization component, i.e., along the z coordinate of the garnet film 110 in Oe. The graph of 9C illustrates the z component of the stray field from the domain wall from the garnet film 110, where the horizontal axis again represents the x-coordinate of the garnet film 110 in nanometers and the vertical axis represents the field strength in Oe.

FIGS. 10A and 10B illustrate top plan views of a magnetic recording head 120 placed on the surface of the garnet film 110 and the domain walls 114 moving with respect to the magnetic recording head 120, as illustrated by arrows 166, due to the application of an external magnetic field. The magnetic recording head 120 may be held stationary with respect to the garnet film 110, while the underlying domain wall 114a is moved beneath the magnetic recording head 120. The domain wall 114a may be oriented and moved in the cross-track or down-track directions or any angle in between, or any desired angle that may be appropriate for the sample under test if the sample is not a recording head.

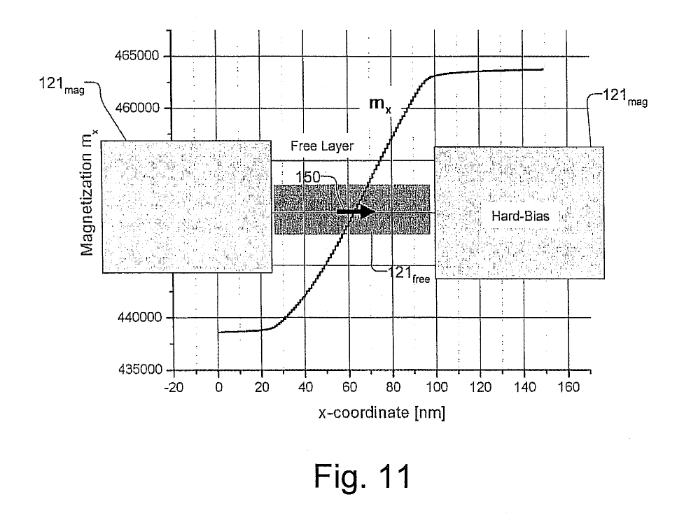

FIG. 11 illustrates a graph of the domain wall profile, similar to that shown in FIG. 9B, except with a schematic illustration of a read sensor 121 of the magnetic recording head 120 positioned over and scaled with respect to the graph. The read sensor 121 includes two permanent magnets 121_{mag}, which produce a hard bias field, and the free layer 121_{free} between the permanent magnets 121_{mag}. As can be seen, the size of the domain wall and the magnetic field that it produces is relatively small compared to the free layer 121_{free}. Moreover, as illustrated with arrow 150, the location of the domain wall and, thus, the magnetic field produced by the domain wall, can be moved with respect to the free layer 121_{free}. Thus, the magnetic field produced by the domain wall may be used as a probe to test, e.g., the spatial response function or the width of the free layer 121_{free} by measuring the output signals from the read sensor 121 as the domain wall is moved relative to the free layer 121_{free}. It should be understood that while FIG. 11 illustrates moving the domain wall in the cross-track direction of the read sensor 121, if desired, the down-track direction may be measured as well.

The read sensor 121 response may be de-convoluted based on the known z-component profile of the domain wall magnetic field, e.g., illustrated in FIG. 9C. The de-convoluted spatial response function R(x) of the read sensor 121 may be determined based on the known domain wall magnetic field H_{z}(x) and the measured read sensor response r(x) using the 2-D Fourier transforms F and the inverse Fourier transform IF of the quotient as follows:

$$\begin{matrix}{R}^{′} ( x ) = \frac{F 〈 r ( x ) 〉}{F 〈 {H}_{z} ( x ) 〉} & eq . 4 \\ R ( x ) = I F 〈 {R}^{′} ( x ) 〉 . & eq . 5\end{matrix}$$

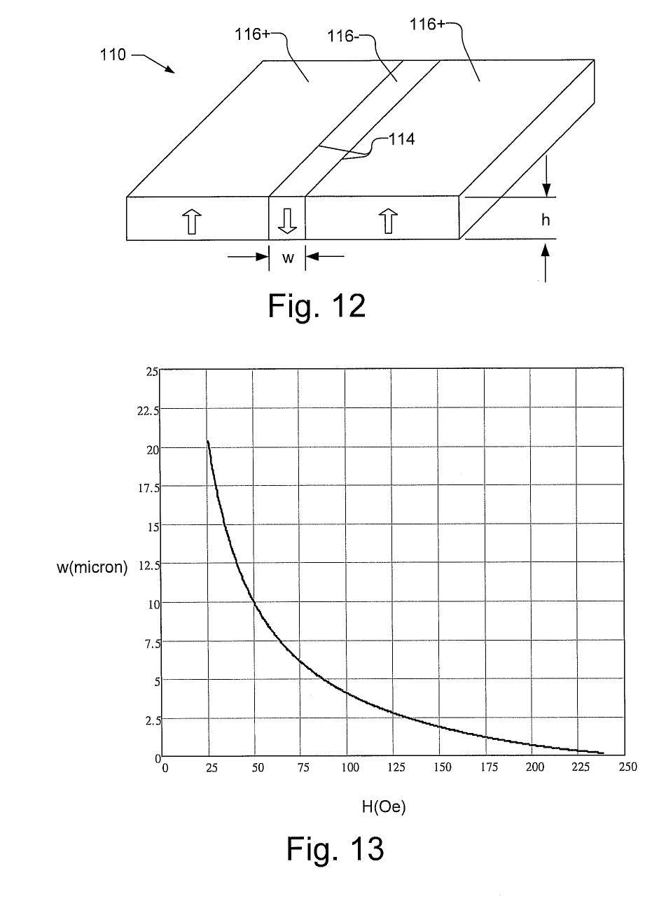

The position of the domain wall is related to the width of a domain. FIG. 12 illustrates a perspective view of a portion of the garnet film 110 of height h and in which three adjacent domains 116+, 116−, and 116+ are illustrated with two domain walls 114, which are separated by a distance w, i.e., the width of the domain 116−. The position of the domain walls 114 is dependent on the domain width w, i.e., w/2, and is related to the external magnetic field H that is applied as follows:

$$\frac{H}{4 π {M}_{s}} = {π}^{- 1} ( 2 \cdot arc tan ( \frac{h}{w} ) - ( \frac{w}{h} ) \cdot ln [ 1 + {( \frac{h}{w} )}^{2} ] ) \qquad eq . 6$$

where 4πMₛ is the saturation magnetization.

FIG. 13 is a graph illustrating the relationship between the width w(microns) and the magnetic field H(Oe). By biasing the stripe domains using a fixed perpendicular field the operation point for the wall displacement can be chosen. Choosing the highest perpendicular field that still maintains a stable parallel stripe array relaxes the requirements of the field control via coil 106 in FIG. 1A used for wall displacement.

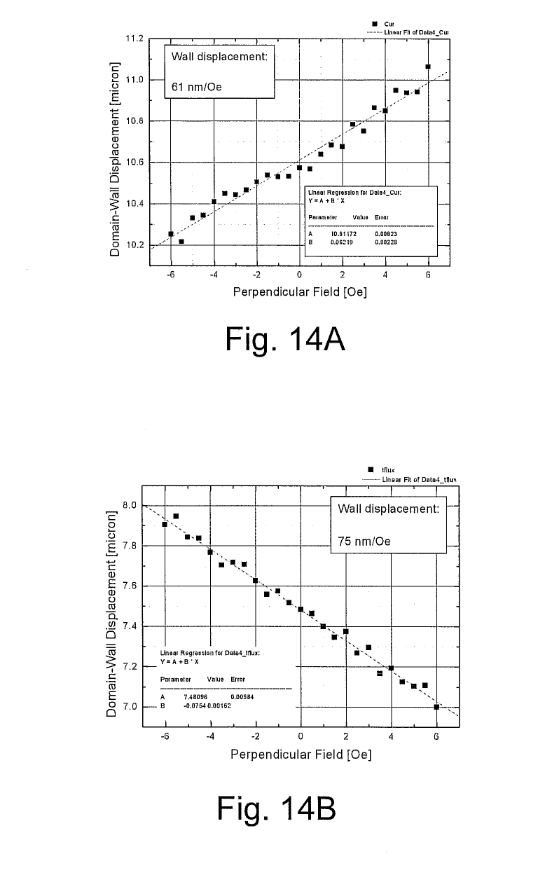

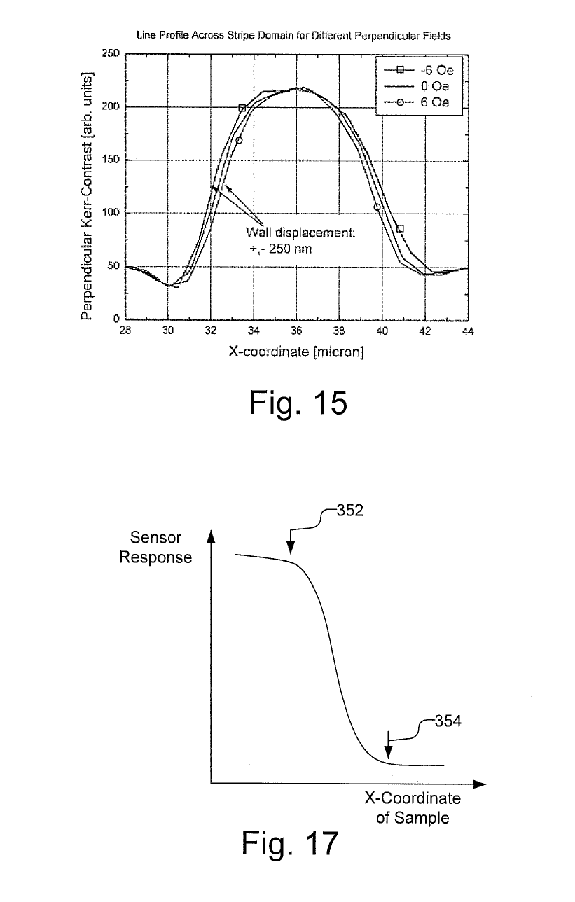

FIGS. 14A and 14B are graphs illustrating measured domain wall displacement with respect to an applied perpendicular magnetic field. The displacement of a domain wall is half the change of the domain width. To measure the domain width, domain wall profiles were measured for a perpendicular magnetic field range of ±6 Oe using interpolated images with three times the raw pixel density. The profiles were fitted to a cubic spline-function and the spline function solved for the roots, with FIGS. 14A and 14B showing the resulting domain width dependence, wherein FIG. 14A corresponds to a domain with the magnetization vector pointing up and FIG. 14B corresponds to a domain with the magnetization vector pointing down. FIG. 15 is a graph illustrating the domain wall displacement for an externally applied perpendicular magnetic field that varies between ±6 Oe. As can be seen in FIG. 15, the domain wall is displaced by approximately ±500 nm over the ±6 Oe magnetic field range.

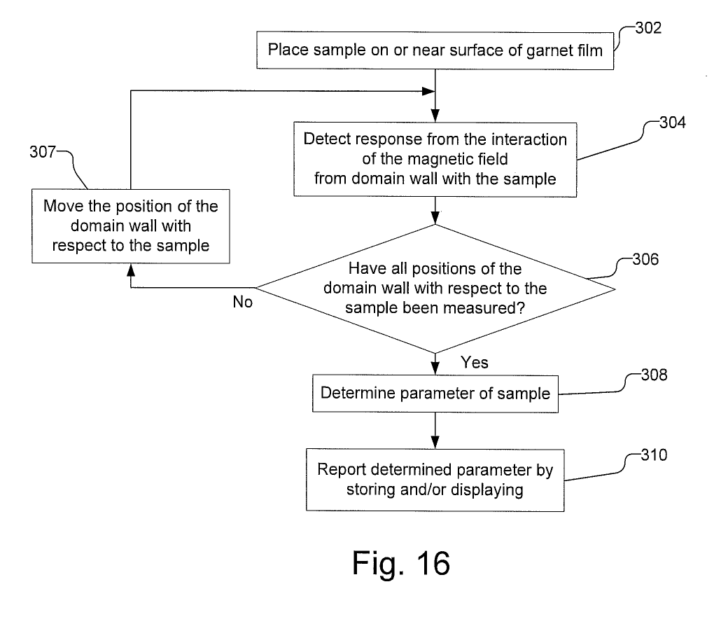

FIG. 16 is a flow chart illustrating a process of using the magnetic field generator 112 that produces a localized magnetic field from a domain wall 114 to produce a measurable response in a sample, measuring that response and using the measurement to determine a desired parameter of the sample. The sample may be a magnetic device, such as a magnetic recording head, which may includes one or both of a read sensor and an inductive write head, as well as other magnetic field sensors or other devices, including Tape Heads. It should also be understood that the sample may be non-magnetic, as well as organic or inorganic. The generation of the measurable response in the sample from the localized magnetic field from the domain wall can be based on a variety of physical effects and processes that are susceptible to a magnetic field, including, but not limited to Magneto-Resistivity, Spin-Tunneling, Hall-effect, Nuclear Magnetic Resonance (NMR), Ferromagnetic Resonance (FMR), and Induction. Due to the localized nature of the magnetic field from the domain wall, the measurable response may provide information about intrinsic material parameters of the sample at a specific location. Moreover, measuring the response when the domain wall, and thus, the localized magnetic field, is positioned at different locations of the sample may provide spatial information, e.g., on the nanometer length-scale, about intrinsic material parameters and/or dimensions of the sample.

As pointed out in FIG. 16 (block 302), the sample is held on or near enough to the surface of the garnet film 110 to be effected by the magnetic field from the domain wall 114, e.g., a distance of no more than approximately the domain wall width (block 302). The orientation of the sample with respect to the domain wall 114 may be determined by appropriate placement of the sample with respect to the magnetic field source 104, or by controlling the orientation of the domain wall 114 using a two axis in plane magnetic field source. The domain wall 114 may be self-aligning or may be initialized as described above. The position of the domain wall 114, and thus, the localized magnetic field produced by the domain wall 114, with respect to the sample may be adjusted to place the localized magnetic field in a desired position with respect to the sample, e.g., by varying the perpendicular magnetic field produced by field source 102 and/or 106.

The response from the interaction between the sample and the localized magnetic field from the domain wall is detected (block 304). By way of example, the response may be in the form of a signal from the sample that is detected via the probe 122, shown in FIG. 1. If desired, other responses, such as Spin-Tunneling and Nuclear Magnetic Resonance may be detected in an appropriate manner. Further, the response may be detected through appropriate imaging, including magneto-optically imaging the sample. For the sake of convenience, the detection of a signal from a magnetic recording head via probe 122 from FIG. 1 will be discussed herein. If it is desired to detect responses from the sample for different positions of the domain wall with respect to the sample (block 306), the position of the domain wall with respect to the sample is then moved (block 307), e.g., by varying the perpendicular magnetic field produced by field source 102 and/or 106. For example, in one embodiment, the magnetic field source 102 applies an offset field that may be between, e.g., ±200 Oe, and that may be an AC or DC field, and which may be used to sweep the domain wall 114 across the sample. Additionally, magnetic field source 106 may be used to apply an additive field of, e.g., ±6 Oe, that maybe an AC or DC field. The additive field of the magnetic field source 106 may be used, e.g., with a different (higher) frequency than the offset field, or to provide better resolution or noise characteristics, or to apply a field for an inductive sample. Thus, the domain wall 114 may be moved in a continuous or step-wise fashion using the offset field from magnetic field source 102, and may further include an additional continuous or step-wise movement using the additive field from magnetic field source 106. The response from the interaction between the sample and the localized magnetic field from the domain wall may be detected at each desired position.

When all positions of the domain wall with respect to the sample have been measured (block 306), the desired parameter may be determined from the detected responses via the processor 130 with the computer-readable program code embodied in the computer-usable medium 132 (block 308). By way of example, the parameter may be the spatial response function of the read sensor or dimensions of the free layer 121_{free}. By way of example, FIG. 17 is a graph illustrating a measured sensor response with respect to the x-coordinate (cross-track direction) of the sample (or interchangeably, the perpendicular drive field), where the arrows 352 and 354, respectively, point to the left and right edges of the sensor. The sensor response illustrated in FIG. 17 is for a moving domain wall driven by an AC field when the domain wall is centered under the sensor by a perpendicular field. It should be understood that the movement of the domain wall may be induced by an AC field or a DC field and that if desired the AC or DC fields may be centered around another offset field, which may also be an AC or DC field. One or more of these combinations of magnetic fields may be produced using a single magnetic field source 102 or two field sources 102 and 106. The shape of the sensor response indicates when the domain wall has moved across the entire sensor in the cross-track direction, e.g., from arrows 352 to 354, as the sensor response goes from a negative to a positive plateau or vice versa. Using the measured sensor response, a parameter such as the spatial response function of the sensor may be determined or the dimension of the free layer 121_{free} can be determined with knowledge of the displacement of the domain wall. It should be understood that, if desired, certain parameters of the sample may be determined from previously measured responses while additional responses at different positions are detected, i.e., block 308 need not necessarily follow the completion of measuring the response from all positions. The determined parameter is then reported by storing in memory 134 and/or displaying on display 136 (block 310).

In some embodiments, e.g., when the sample is a reader element, it may be desirable to decouple the effect on the sample from the domain wall 114 and the effect on the sample from the perpendicular magnetic field, e.g., produced by magnetic field generator 102, that is used to move the domain wall 114. In other words, the sample produces a sample output signal caused by the magnetic field from the domain wall 114 that includes a background signal that is caused by the perpendicular magnetic field from the magnetic field generator 102 or 106. If desired, the background signal may be subtracted from the sample output signal, e.g., using base-line subtraction or by differentiating the response profile. The 50% half-width of the differentiated response profile can then be used as a measure of the geometry of the sample.

In one embodiment, at each position of the localized magnetic field from the domain wall with respect to the sample, the domain wall 114 is oscillated, i.e., moved back and forth, at a desired frequency, e.g., a few Hertz to 10 MHz or more if necessary to produce the desired effect in the sample. The oscillating movement of the domain wall 114 may be in the down track or cross-track direction as desired. The oscillating domain wall 114 may be produced by, e.g., coil 106 shown in FIG. 1A or coil 102 if it is capable of producing the desired frequency. Oscillations of the domain wall 114 may be used, e.g., to reduce the domain wall coercivity and reduce or eliminate pinning effects by local imperfections of the garnet film 110. Additionally, when the sample is a write element or other inductive device, oscillations of the domain wall 114 may be used to inductively produce a voltage signal in the write element, which is detected (block 304) and used to determine, e.g., the presence and operation of a write pole or parameters such as, e.g., the throat height. For example, for some write heads, the domain wall may be oscillated between 1 MHz to 10 MHz with 5-15 Oe peak to peak, but other write heads may require other amplitudes or frequencies. The amplitude of the induced voltage in the write coil is detected, which would be significantly lower if the write pole is missing. Additionally, by scanning the oscillating domain wall 114 over the width of the write element, the spatial response function or dimension of the write element may be determined.

The oscillating domain wall 114 positioned under or in the vicinity of the write pole of a write element produces a time varying flux in the write head that generates a voltage in the write coil that can be measured via probe 122. The induced voltage depends on the frequency of the oscillation, as well as the amplitude of the oscillation and the average position of the oscillating domain wall 114 relative to the write pole. In one embodiment, the average position of the oscillating domain wall 114 may be controlled by the perpendicular magnetic field produced by magnetic field generator 102, while the frequency and amplitude of the oscillations may be controlled by the magnetic field produced by the magnetic field generator 106.

By way of example, in one embodiment, the amplitude of the oscillation may be larger than the write pole width, while the average position of the domain wall 114 may be under the write pole, and the induced voltage may be measured as a function of time, e.g., using an oscilloscope. In this embodiment, the measurement may yield information regarding the geometry of the write pole, provided the linear velocity of the domain wall 114 is known, as well as the efficiency of the write head. In another embodiment, the amplitude of the oscillation may be larger than the write pole width, while the average position of the domain wall 114 may be under the write pole, and the induced voltage may be measured using lock-in detection, as described below. In this embodiment, the measurement provides information on the write head efficiency. Lock-in detection results in the loss of time information, and thus, geometry information would generally not be extracted. However, by scanning the average position of the domain wall 114 across the write pole, geometry information about the write pole may be extracted. In yet another embodiment, the amplitude of the oscillation may be smaller than or on the same order as the write pole width and the induced voltage may be measured using lock-in detection, as described below. By scanning the average position of the domain wall 114 across the write pole, different average positions are generated, which may be used to extract geometry information about the write pole.

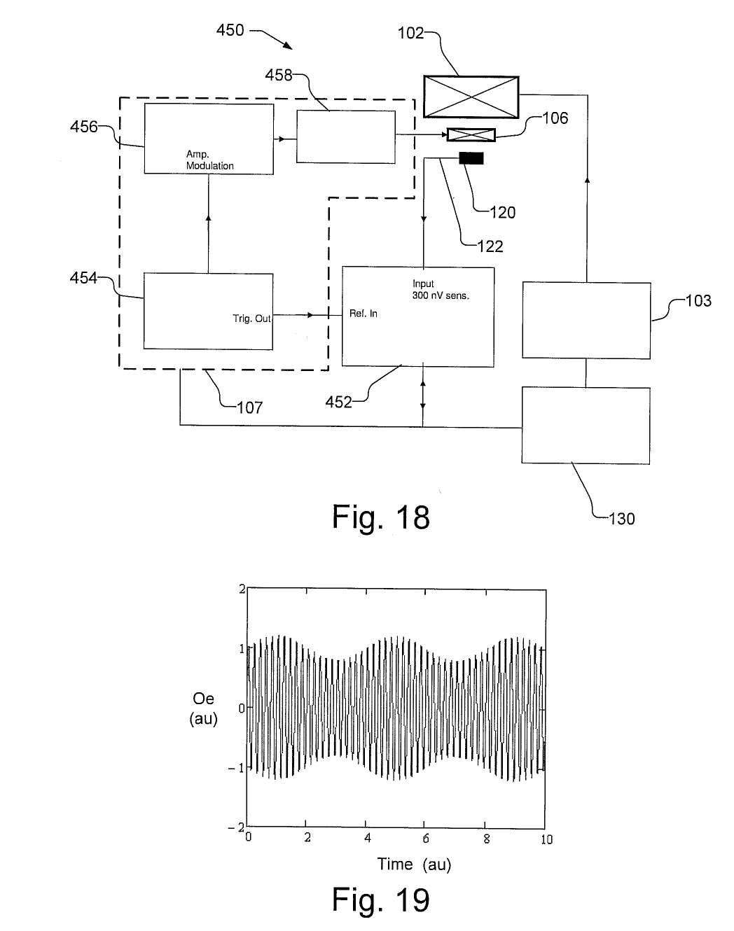

FIG. 18 schematically illustrates one embodiment of circuitry 450 that may be used to excite and measure the response from a sample 120, e.g., an inductive element such as a write head, using an AM modulated excitation field. The circuitry 450 may be used with device 100 illustrated in FIG. 1A if desired, like designed elements being the same. It should be understood that FIG. 18 does not show all of the components of the device 100 from FIG. 1A for the sake of clarity of the circuitry 450. As illustrated in FIG. 18, a lock-in amplifier 452 may be used in place of the amplifier 126 and digitizer 124. If desired, a digitizer 124 may be used with the lock-in amplifier or the digitizing may occur within the processor 130 using appropriate software or the lock-in amplifier has a digital interface. Some lock-in amplifiers 452 include an auxiliary voltage output port that may be used, if desired, as the connection between controller 103 and processor 130. The lock-in amplifier 452 is coupled to and receives a reference signal from a 25 kHz function generator 454 within the controller 107. The lock-in amplifier 452 is adjusted according the properties of the signals and in the present embodiment may be set with a 1 second time constant. The controller 107 may include the 25 kHz function generator 454, a 2.5 MHz function generator 456 and an RF-Amplifier 458, which is coupled to the magnetic field generator 106. With the use of function generators 454 and 456 in the controller 107, the magnetic field generator 106 produces an AC magnetic field of 2.5 MHz that is further amplitude-modulated at 25 KHz. Of course, other frequencies may be used if desired. FIG. 19 is a graph illustrating the resulting AM modulated excitation-field waveform produced by the magnetic field generator 106 in arbitrary units of field versus time. In addition, a DC or AC (of a different frequency) offset magnetic field may be produced, e.g., by magnetic field generator 102, to scan the oscillating domain wall 114 excited by the AM modulated field waveform across the sample 120. If desired, a single magnetic field source 102 or 106 may be used to produce the AM modulated excitation field as well as the offset magnetic field. Moreover, if desired, the modulated excitation field may be produced in alternative forms, such as including DC components or using FM modulation. With the use of a modulated signal, such as that shown in FIG. 19, and lock-in amplifier 452, the signal to noise ratio is improved and thus may be used advantageously with inductive samples as described above.

As an alternative, in some cases the reference signal for the lock-in amplifier can be the same as the 2.5 MHz signal generated by the generator 456, e.g., in FIG. 18, the lock-in amplifier 452 receives the 2.5 MHz signal from generator 446. In this case, the out-of-phase component of the lock-in amplifier is used to measure the induced voltage at the output terminal of the inductive device, e.g. an inductive write head. Any parasitic 2.5 MHz signal, i.e. a signal that is not inductively generated by the inductive device, will appear as the in-phase component of the lock-in detection.

The lock-in signal detection may be used with read sensor measurements as well. The signal to noise ratio may be improved and by choosing the appropriate modulation scheme, e.g., modulating the domain wall 114 motion, the background signal may be eliminated. Additionally, modulation of other signals, such as the bias current to the read head through probe 122, may be used to lock-in detect the sensor output.

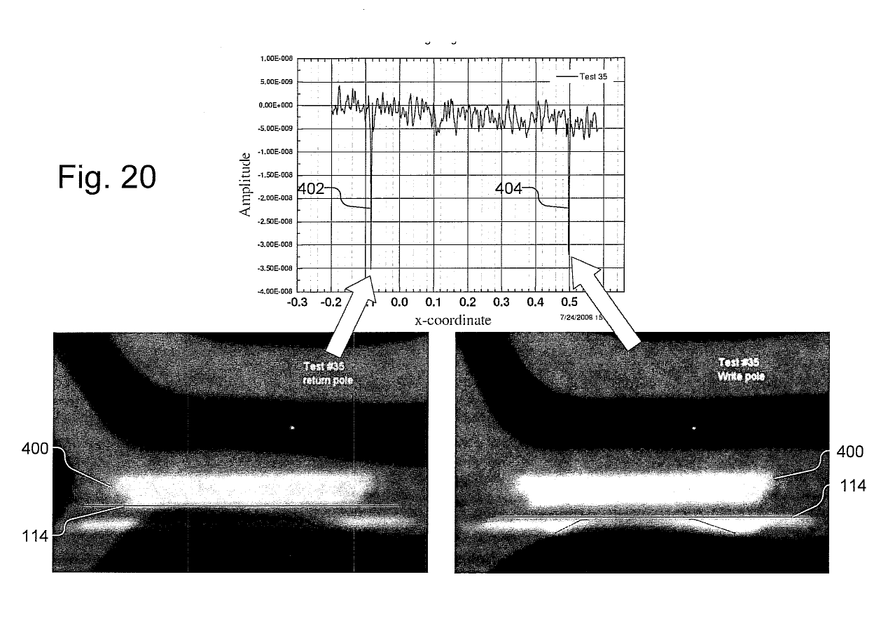

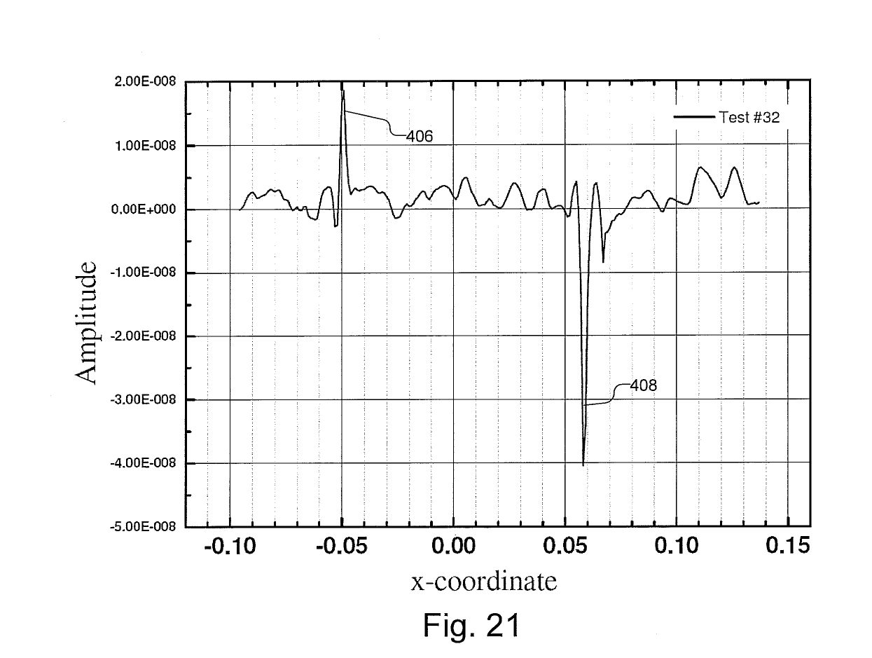

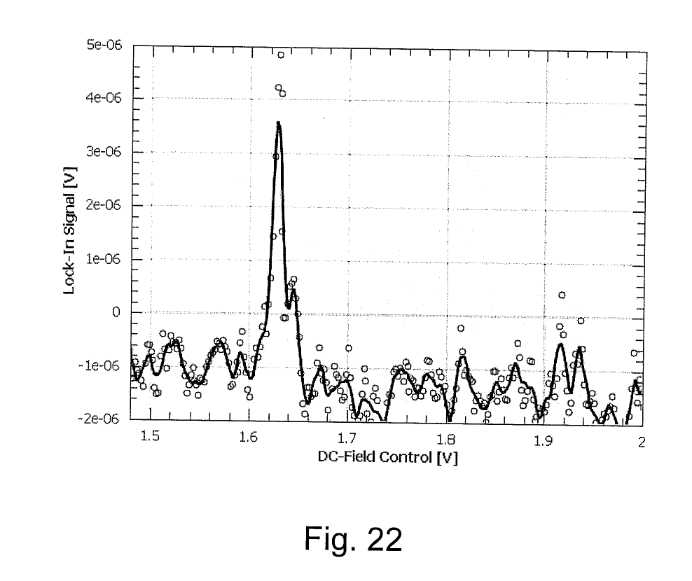

FIG. 20 illustrates a graph showing the amplitude of the writer signal and an x-coordinate position of a domain wall 114 with respect to a writer, which is produced by incrementing a perpendicular offset DC-field while producing the AM modulated excitation field, such as that shown in FIG. 19, at each offset increment (and, thus, the x-coordinate position is equivalent to the field control voltage for the incrementing offset DC field). FIG. 20 also illustrates two images of the domain wall (shown by line 114) and a writer element 400, where the images were automatically taken at the time of the signal peak as illustrated by the arrows. Data is taken by incrementing the perpendicular DC-field and an image is automatically stored whenever a signal peak is detected. The signal peak 402 is caused by the return pole in the writer and the signal peak 404 is caused by the writer pole. FIG. 21 is a similar graph that illustrates the sensitivity of the signal to the domain wall 114 passing over the leading edge 406 of the return pole and the trailing edge 408 of the return pole of a writer. FIG. 22 is another similar graph, where the x axis is labeled DC field control, which shows the lock-in signal during a cross-track scan of the domain wall 114 over a writer.

Alternatively, instead of measuring an inductively produced voltage signal via probe 122, the inductance from an inductive sample may be measured through probe 122. The position of the magnetic field of the domain wall 114 with respect to the inductive element will alter the measured inductance of the sample. Thus, the inductance may be measured and used to determine the desired metric of the sample.

In another embodiment, the oscillating movement of the domain wall 114 (block 304 in FIG. 16) may be used to simulate field switches at the magnetic recording head 120, e.g., the signals produced by moving bits on an actual spinning magnetic disk at the magnetic recording head 120. The domain wall 114 may be oscillated at a frequency that approximates the angular velocity of a rotating disk or if desired at other frequencies, e.g., lower frequencies. Advantageously, by oscillating the domain wall 114, the simulation of the spinning magnetic disk is produced without requiring actual relative movement between the magnetic recording head 120 and the garnet film 110. Using the signals detected from the magnetic recording head 120 due to the oscillating domain wall 114, parameters, such as the performance, repeatability or magnetic stability of the magnetic recording head 120 (or other similar device) can be determined (block 308).

In another embodiment, a temperature control device, such as a heater, is directly or indirectly thermally coupled to the garnet film 110 and/or the magnetic recording head 120. As illustrated in FIG. 1A, by way of example, the garnet film 110 may be directly coupled to a temperature control device 128, while a controller 129 for the temperature control device 128 is connected to the processor 130. In another embodiment, rather than directly controlling the temperature directly with a heater, an environmental chamber may be used. In one embodiment, the temperature control device 128 may be used to raise or lower the temperature of the garnet film 110 to alter the magnitude of the magnetic field produced by the domain walls 114. The field created by the domain wall is proportional to the saturation magnetization which is temperature dependent. When needed for some applications, the magnitude of the magnetic field produced by the domain wall can be decreased by heating or increased by cooling rather than operating at a fixed field. The garnet film 110 can be manufactured with different Magnetization-vs.-Temperature characteristics, as known in the art, and should be tailored to have a strong Magnetization-vs.-Temperature characteristic so that the magnitude of the magnetic field produced by the domain wall 114 may be altered by a temperature change that produces limited changes to the properties of the recording head.

Additionally, it may be desirable to characterize a recording head 120 throughout a desired thermal range, such as 20° C. to 80° C. Thus, the sensor properties of the recording head 120 at different temperatures are to be determined. In an embodiment, in which the magnetic recording head 120 is thermally coupled to the temperature control device 128 through the garnet film 110, as illustrated in FIG. 1A, the Magnetization-vs.-Temperature characteristics of the garnet film 110 should be tailored so that domains are stable and a high enough and consistent field is generated over the desired temperature range of the sample. Thus, the temperature of the garnet film 110 may be set at a desired temperature to perform thermal testing of the sample. As an example, with an magnetic recording head 120 in contact with the garnet film 110, the temperature of the garnet film 110 may be elevated to 80° C. (a typical operating temperature inside a hard disk drive), and the magnetic recording head 120 may be tested at this desired temperature. By way of example, parameters such as the spatial response function or the dimensions of the magnetic recording head 120 can be measured and/or the performance of the magnetic recording head 120 with high frequency field switching, as discussed above, may be measured at the desired temperature. In other embodiments, the temperature of the magnetic recording head 120 may be controlled with a temperature control device 128 that has no or little thermal effect on the garnet film 110. For example, the temperature control device 128 may be a laser that heats the magnetic recording head 120. Alternatively, the temperature of the magnetic recording head 120 may be internally manipulated, e.g., by controlling internal components of the magnetic recording head 120, e.g., as a heater (such as a Dynamic-Flying-Height element) or writer element, through contacts in the probe 122.

In another embodiment, where the sample under test includes a Dynamic-Flying-Height (DFH) function, the performance of the sample, e.g., the performance of the write head, read sensor or both, may be determined as a function of the flying height. The DFH element is typically in the form of a heater incorporated into the head, with additional contact pads for external connection. The DFH element can be heated and cooled to function as an adjustment mechanism to internally displace the write element, read sensor or both towards or away the disk. Thus, by applying a bias to the additional contact pads for the DFH element via the probe 122, the position of the write element (or read sensor) can be adjusted towards and away from the air bearing surface. The domain walls 114 may be moved relative to the sample (block 304) (e.g., oscillated relative to the write element) for different heights of the read sensor and/or write element to determine parameters such as the performance of the read sensor and/or write element at the different heights or the verification/qualification of the DFH operation.

In another embodiment, the magnetic field from the domain wall 114 can be used to measure displacement of a read sensor and/or write element in the magnetic recording head 120, e.g., produced by internal or external microactuation. By way of example, next generation read/write heads may include internalized microactuation for fine positioning of the read/write head relative to the track on the disk, in a manner similar to DFH discussed above (where the microactuation for position of the read/write head is cross-track, while DFH microactuation is perpendicular to the air bearing surface). With the use of the magnetic field from the domain walls 114, the microactuation capability of a head can be tested. For example, the domain wall 114 can be positioned under the read sensor 121, while the head is microactuated to move the read sensor 121 with respect to the garnet film 110. Generally, the domain wall 114 may be held stationary while microactuating the read sensor 121, but if desired, the domain wall 114 also may be moved, either during testing or to align the domain wall 114 with respect to the read sensor 121 prior to microactuation. Movement of the read sensor 121 with respect to the magnetic field from the domain wall 114 will produce a signal that can be used to analyze the performance, e.g., verification/qualification, of the microactuation. Additionally, some combination of measurements may be performed, such as moving the domain walls to calibrate the position (and sensitivity) of the read sensor 121, then microactuating the read sensor 121 to measure this same signal vs. displacement.

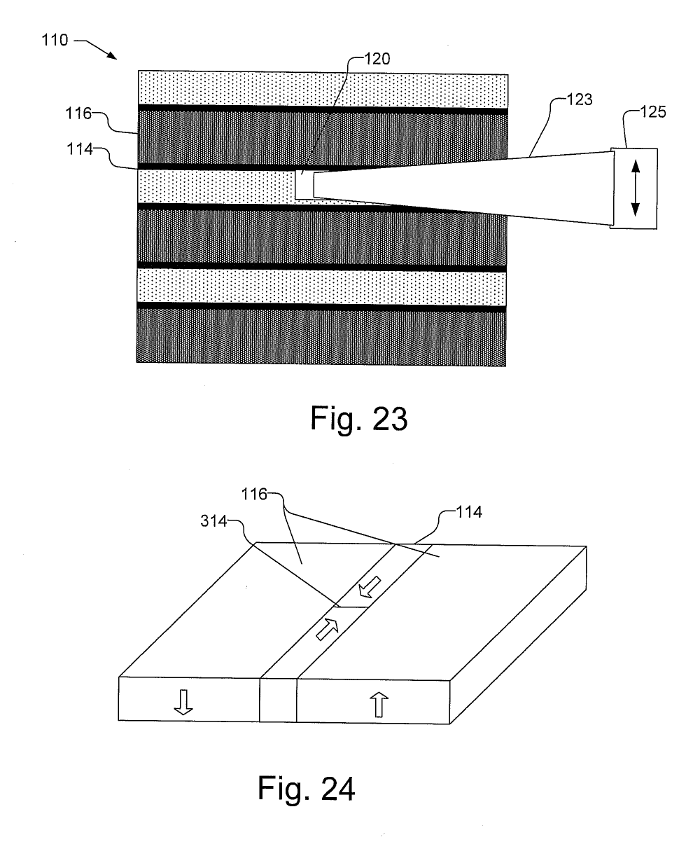

Additionally, an external microactuation of the magnetic recording head 120 may be used. FIG. 23 illustrates an embodiment in which a magnetic recording head 120 is held by a suspension 123 near or on the surface of the garnet film 110 and a microactuator 125 coupled to the suspension 123 is used to move the magnetic recording head 120 with respect to the garnet film 110. It should be understood that the various elements illustrated in FIG. 23 are not to scale with respect to each other. In one embodiment, the head 120 may be held in contact with the garnet film 110, but if desired, the head 120 may be separated from the surface of the garnet film 110, e.g., by a distance of the same order as the domain wall width. In this embodiment, the domain wall 114 may be held stationary or may be moved while the microactuator 125 moves the magnetic recording head 120, either during testing or to align the domain wall 114 prior to microactuation. The movement of the read sensor in the magnetic recording head 120 with respect to the magnetic field from the domain wall 114 will produce a signal that can be used to determine the verification/qualification of the microactuator 125. In another embodiment, the external microactuation of the magnetic recording head 120 may be used by the device 100 to produce movement of the magnetic recording head 120 with respect to the garnet film, e.g., to produce relative movement of the magnetic field from the domain wall 114 with respect to the head 120. Thus, the external microactuation of the head 120 may be performed instead of or in addition to the movement of the domain wall 114 described in block 304 in FIG. 16.

In another embodiment, the stray field from a domain wall 114 in the garnet film 110 may be used to induce or alter local ferromagnetic resonance (FMR) conditions in magnetic materials for a spatially resolved FMR measurement. Typically, the FMR frequency of a magnetic material is determined by the magnetic field that is acting on the material. Conventionally, a homogenous magnetic field is used, which results in the FMR frequency being the same throughout the magnetic sample. Inducing and measuring homogenous FMR conditions is well understood in the art. In accordance with the present embodiment, however, the domain wall 114 produces a localized magnetic field. By placing a magnetic sample on or near the surface of the garnet film 110, the stray field from the domain wall 114 can induce or alter the local FMR conditions in the sample and therefore provides a spatially resolved FMR measurement, which can be measured via probe 122 in a conventional fashion. The position of the domain wall 114 with respect to the sample may then be changed to measure the local FMR conditions at the new position. By measuring the FMR at a plurality of positions of the domain wall 114 with respect to the sample, the spatial dispersion of the FMR can be obtained. Using the spatially resolved FMR measurement, various parameters of the sample can be deduced, such as the stiffness-field and the biasing condition of the free-layer.

In another embodiment, a moving domain wall 114 may be used to magneto-optically detect, via the Faraday Effect or the Kerr effect, and magneto-optically image local stray fields emanating from imperfections and defects in a magnetic material sample through the interaction of the domain wall 114 with these local stray fields in the sample. Local stray fields from the sample act as pinning sides for the domain wall 114, which hamper the displacement of the domain wall 114. By observing the distortions of the motion of the domain wall 114, the location of defects in the sample may be detected. Thus, for example, the motion of the domain wall 114 may be magneto-optically imaged using a polarization microscope utilizing the Faraday Effect for transmitted light or the Kerr effect for reflected light and the location of changes in the statistics of motion of the domain wall 114 may be used to indicate the presence of defects or other characteristics of the sample. Thus, the motion of the domain wall 114 may be magneto-optically imaged with the sample present on or near the surface of the garnet film 110. Changes in the motion of the domain wall 114 can then be an indication the location of a defect or other characteristic of the sample. The method can be applied to, but is not limited to, magnetic media used in magnetic data storage. In one embodiment, the motion of the domain wall 114 is magneto-optically imaged while sweeping the domain wall 114, e.g., with an AC field. However, if desired, the domain wall 114 may be moved in steps, e.g., with a varying DC field. The light source for the magneto-optical imaging may be e.g., broadband light, a laser or pulsing laser and the detector may include, e.g., a camera, a light sensor, or photomultiplier tube. The use of a broadband (e.g., white) light source and camera may be suitable for low frequency or DC field imaging, while the use of a pulsed laser and light sensor may be suitable for real-time AC field imaging. In one embodiment, the domain walls may be excited over a large area with a strong, e.g., AC magnetic field with an amplitude that is close to saturation of the garnet film 110. The excitation frequency may be higher than the frame-rate of the camera or other detector that is used, and thus, the frames are cumulatively averaged. The resulting averaged magneto-optic image will have no features, unless a domain wall is pinned by a localized field, such as that emanating from a sample defect. The pinned domain wall will thus produce a contrast that can be observed and from that the location of the defect can be determined.

In another embodiment, a vertical Bloch line in a domain wall 114 may be used as a nanometer magnetic point source. Bloch lines and their production and use as a storage device generally described in U.S. Pat. No. 4,001,794, which is incorporated herein by reference. In the present embodiment, however, the Bloch line is used as a magnetic source probe, as opposed to a storage device. FIG. 24 illustrates a perspective view of a garnet film 110 with domains 116 and a domain wall 114 between the domains 116 and a vertical Bloch-line 314. The domain wall 114 is a two dimensional structure, and thus, use of the domain wall 114 as magnetic source provides information in one dimension. A vertical Bloch-line (VBL) 314 is a one-dimensional substructure of a domain wall 114. Thus, the vertical Bloch-line 314 may serves as a point magnetic field source at the surface of the magnetic thin film 110. Consequently, the vertical Bloch-line can yield information from a sample, in a manner similar to that described for a domain wall 114, but because the vertical Bloch-line 314 is a point magnetic field source, the information provided is in two dimensions. The position of the VBL may be controlled by the in-plane field created by the coils 104.

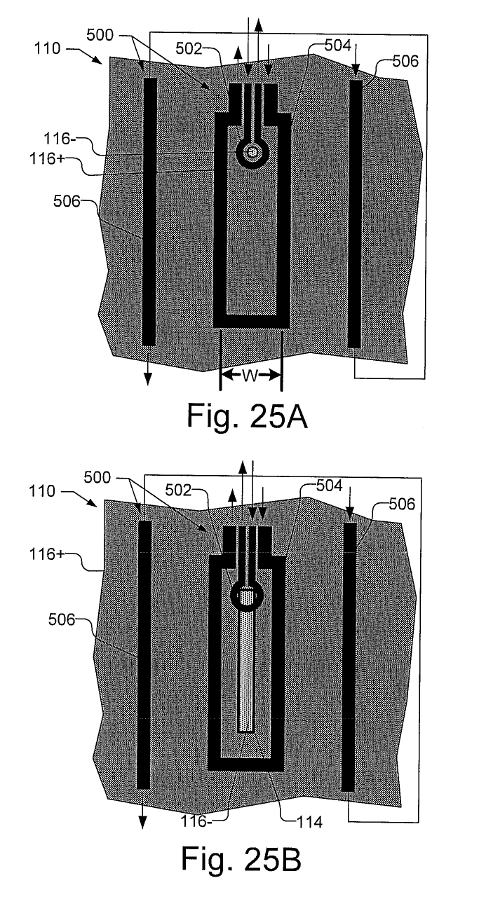

FIG. 25A illustrates a top plan view of a garnet film 110 in accordance with another embodiment. As illustrated in FIG. 25A, a perpendicular magnetic field generator 500 includes integrally formed sets of conductors on the garnet film 110. The conductors may be, e.g., lithographically produced from a conductive material, such as metal, e.g., gold, copper or aluminum, or alloys thereof, on the garnet film 110, using well known deposition and lithographic techniques. The magnetic field generator 500 may include a first set of conductors 502 that forms a loop (sometimes referred to herein as loop 502) and a second set of conductors 504 that forms another loop (sometimes referred to herein as loop 504) that is outside and surrounds loop 502. The loops 502 and 504 are such that current enters and exits the conductors in opposite directions, illustrated by arrows in FIG. 25A, thereby producing a perpendicular magnetic field inside the respective loops 502. In one embodiment, the loop 504 may have a width W of approximately 30 μm.

If desired, the magnetic field generator 500 may include a third set of conductors 506 on the garnet film 110 that are located outside loops 502 and 504 and are configured so that current enters and exits the conductors in the same direction, as illustrated by the arrows in FIG. 25A. The third set of conductors 506 may be used to produce a magnetic field gradient in the garnet film 110 between the third set of conductors 506 to laterally displace any domain formed within the loop 504.

The garnet film 110 with the perpendicular magnetic field generator 500 may be initialized to produce a bubble domain or a stripe domain. In one embodiment, the garnet film 110 is initialized by applying a perpendicular DC magnetic field with a value higher than the saturation field of the garnet film 110 to eliminate all domains within the film. For example, a 200 Oe magnetic field produced, e.g., by the perpendicular magnetic field source 102 may be used. Alternatively, the loop 504 may be used to produce a field sufficient to eliminate all domains within the loop 504. The loop 504 may then be turned on to produce a local confinement field for domains that will be created within the loop 504. By way of example, the loop 504 may produce a field magnitude of 50 Oe in the center of the loop 504, which when combined with the 200 Oe saturation magnetic field results in a field of 250 Oe in the center of the loop 504. The confinement field may be turned on before or after the saturation field, or in the embodiment where the loop 504 is used in place of the magnetic field source 102, the confinement field and saturation field may be the same. The DC saturation field produced by magnetic field source 102 may be reduced to produce a field inside the loop 504 that is lower than the saturation field of the garnet film 110, but is not low enough to generate domains within the loop 504. For example, the saturation field may be reduced to 100 Oe, resulting in a total field of 150 Oe inside the loop 504.

A current pulse is then produced through loop 502 to produce a local field, i.e., a field within loop 502, that opposes the magnetization of the garnet film 110 and, which will nucleate a single bubble domain 116 inside the loop 502. Thus, the pulse should be large enough to nucleate a domain 116, e.g., a total field of −80 Oe within the loop 502. Because the total field within the loop 504 is e.g., 150 Oe (as described above), the magnitude of field produced by loop 502 should be −230 Oe within loop 502, producing a net of −80 Oe within the loop 502. A pulse may be used to produce the fairly high magnetic field, but the pulse should be of sufficient duration to nucleate the domain 116, e.g., 100 ns. As illustrated in FIG. 25A, a bubble domain 116 is formed within loop 502 and has a magnetization, e.g., pointing down, that is opposite the magnetization of the surrounding area, e.g., pointing up.

With the domain 116 formed, as illustrated in FIG. 25A, the field within loop 504 may be controlled to change the size and/or shape of the domain. For example, by reducing the field within the loop 504, the bubble domain 116 will form a strip domain, as illustrated in FIG. 25B. By way of example, the total field within loop 504 may be dropped to 50 Oe, e.g., by changing the magnitude of (or eliminating) the saturation field produced by magnetic field source 102 and/or altering the field produced by loop 504 itself. If desired, the field within the loop 504 may be increased again to create a single bubble domain 116 that is centered within the loop 504. One possibility to confine a large number of bubble domains is to create a hexagonal lattice of bubbles, i.e. bubbles maximally packed in rows and columns. This arrangement is inherently stable when confined by some topological or other structure which can be orders of magnitude larger than one bubble diameter. Once created, no external field is required to maintain this bubble lattice. A bubble lattice is created by applying a large in-plane field that tilts the magnetization into the plane and subsequently removing this field.

By reducing the external saturation field produced by magnetic field source 102 to 0 and maintaining the field produced by loop at 50 Oe within the loop, the bubble domain will turn into a stripe domain. Advantageously, by forming a stripe domain 116 in this manner, then loading the sample, the sample will only be exposed to the very local fields from loop 504, optionally conductors 506, and the fields from the domain 116 and domain wall 114 and will not be exposed to a much larger homogeneous external field from the external magnetic field source 102. Alternatively, by reducing the external magnetic field from magnetic field source 102 to a negative field, e.g., −50 Oe, the total magnetic field at the center of the loop 504 can be controlled to be 0, and thus, the sample is exposed to little or no magnetic field except the field from the domain wall 114.

In operation, the loop 504 generates an inhomogeneous perpendicular field with a minimum value in the center, which may be 0 in some embodiments. The position of the domain wall 114 may be controlled by adjusting the domain width (in case of stripe) or diameter (in case of bubble) by altering the field within loop 504, i.e., by changing the current through the loop 504. As previously described, a typical change of ±6 Oe will vary the domain width by approximately 1 μm. In one embodiment, the third set of conductors 506 may be used to produce a lateral translation of the stripe or bubble domain without changing the domain's dimensions. By applying an appropriate current through the third set of conductors 506, a perpendicular field gradient will be produced within the loop 504, with the direction of the field gradient depending on the polarity of the current. In one embodiment, the third set of conductors 506 may be used to make large displacements of the position of the domain 116 to move the domain wall 114 in the vicinity of the sample and the loop 504 may be used to produce small excursions of the domain wall 114 using AC or DC currents.

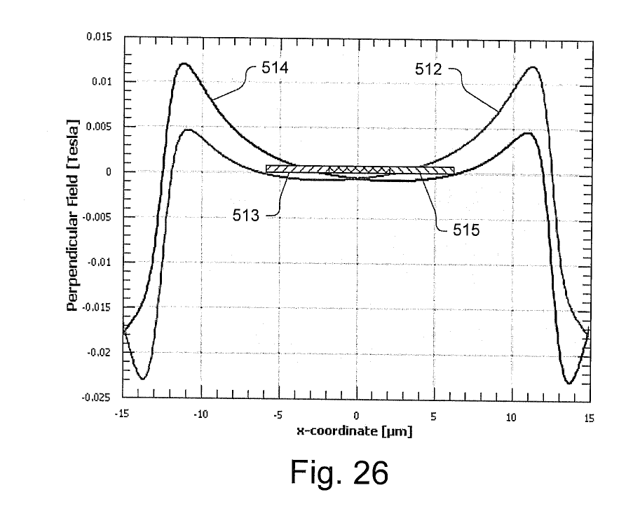

FIG. 26 illustrates the domain confinement and positioning using the loop 504 and conductors 506 of the magnetic field generator, where the vertical axis represents the perpendicular field, and the horizontal axis represents the x-coordinate along the garnet film 110. Curve 512 illustrates the perpendicular field produced by the loop 504 with a positive gradient from conductor 506, while curve 514 illustrates the perpendicular field produced by the loop 504 with a negative gradient from conductor 506. Additionally, FIG. 26 illustrates the position of the domain 116 produced with field illustrated in curve 512 with the block 513 and the position of the domain 116 produced with the field illustrated in curve 514 with the block 515. Thus, as can be seen, the magnetic field generator 500 can effectively change the position of the domain 116 and, thus, the domain wall 114. The localized stripe domain 116 shown in FIG. 25B may be contracted into a bubble domain or expanded back into a stripe domain by applying an appropriate perpendicular magnetic field from the magnetic field generator 500 once the domain is nucleated. Additionally, if desired, the magnetic field generator 500 may be dual-axis by using additional conductors to control the position of domain 116 (and the domain wall 114) in the X and Y positions, which may be particularly useful if a bubble domain is used.

Although the present invention is illustrated in connection with specific embodiments for instructional purposes, the present invention is not limited thereto. Various adaptations and modifications may be made without departing from the scope of the invention. For example, the domain wall may be between stripe domains or bubble domains. Therefore, the spirit and scope of the appended claims should not be limited to the foregoing description.

What is claimed is:

1. An apparatus comprising:
a first magnetic field generator having a surface, the magnetic field generator comprising a magnetic thin film in which there are two magnetic domains with a domain wall between the two magnetic domains, wherein a magnetic field is produced by the domain wall;
a second magnetic field generator positioned relative to the first magnetic field generator so that a variation in a magnetic field produced by the second magnetic field generator changes the position of the domain wall; and
a probe configured to be electrically coupled to a sample while the sample is held sufficiently close to the surface of the first magnetic field generator to be effected by the magnetic field produced by the domain wall.

2. The apparatus of claim 1, wherein the magnetic thin film comprises ferrimagnetic garnet.

3. The apparatus of claim 2, wherein the ferrimagnetic garnet has a perpendicular anisotropy between 4000 Oe to 8000 Oe and a saturation magnetization 4πMₛ that is no less than 255 Oe.

4. The apparatus of claim 2, wherein the ferrimagnetic garnet is polycrystalline or monocrystalline.

5. The apparatus of claim 1, further comprising a processor coupled to the probe and coupled to the second magnetic field generator, the processor configured to receive a signal from the probe.

6. The apparatus of claim 5, wherein the processor is configured to analyze a plurality of signals from the probe.

7. The apparatus of claim 6, wherein the processor is configured to analyze the plurality of signals from the probe to determine at least one of a spatial response function, a dimension of the sample, a spatial dispersion of the ferromagnetic resonance of the sample, and a repeatability function that measures performance stability of the sample.

8. The apparatus of claim 5, wherein the probe is configured to receive at least one of a voltage signal and an inductance signal from the sample.

9. The apparatus of claim 5, wherein the processor is configured to analyze a signal from the probe to determine at least one of spatially resolved ferromagnetic resonance of the sample, and nuclear magnetic resonance of the sample.

10. The apparatus of claim 1, further comprising a controller coupled to the second magnetic field generator, the controller configured to control the second magnetic field generator to vary the magnetic field produced by the second magnetic field generator to change the position of the domain wall.

11. The apparatus of claim 9, wherein the controller is configured to control the second magnetic field generator to oscillate the magnetic field to oscillate the position of the domain wall.

12. The apparatus of claim 11, wherein the controller is configured to control the second magnetic field generator to modulate the oscillation of the position of the domain wall.

13. The apparatus of claim 12, further comprising a lock-in amplifier coupled to the probe.

14. The apparatus of claim 11, wherein the sample comprises an inductive device and the oscillating magnetic field from the domain wall produces a voltage signal in the sample, the probe being configured to receive the voltage signal.

15. The apparatus of claim 14, wherein the sample is a write head.

16. The apparatus of claim 1, wherein the sample includes a Dynamic-Flying-Height element for moving at least one of a write head and a read sensor, and the probe comprises contacts for the moving at least one of the write head and the read sensor.

17. The apparatus of claim 11, further comprising:
a third magnetic field generator positioned relative to the first magnetic field generator so that a variation in a magnetic field produced by the third magnetic field generator changes the position of the domain wall; and
a second controller coupled to the third magnetic field generator, wherein the second controller is configured to control the third magnetic field generator to scan the position of the magnetic field across the sample while the second magnetic field generator oscillates the position of the domain wall.

18. The apparatus of claim 11, wherein the controller is configured to scan the position of the magnetic field across the sample while oscillating the domain wall.

19. The apparatus of claim 5, further comprising contacts for a microactuator that moves the sample, wherein the processor is configured to control the microactuator to change the position of at least a portion of the sample with respect to the first magnetic field generator.

20. The apparatus of claim 19, wherein the sample is a read/write head and the microactuator is internal to the read/write head, the contacts for the microactuator are on the probe, and the microactuator changes the position of at least one of the read sensor and the write head with respect to the first magnetic field generator.

21. The apparatus of claim 19, wherein the microactuator is external to the sample and wherein the microactuator changes the position of all of the sample with respect to the first magnetic field generator.

22. The apparatus of claim 1, further comprising a heat source thermally coupled to the sample.

23. The apparatus of claim 1, further comprising a heat source thermally coupled to the first magnetic field generator.

24. The apparatus of claim 1, further comprising contacts for a heat source within the sample.

25. The apparatus of claim 1, wherein the sample is a read/write head and the probe is configured to be electrically coupled to the read/write head while the read/write head is held a distance from the first magnetic field generator that is less than a width of the domain wall.

26. The apparatus of claim 1, wherein the second magnetic field generator is positioned to produce a magnetic field that has a normal component with respect to the surface of the first magnetic field generator.

27. The apparatus of claim 1, wherein the second magnetic field generator is formed from conductors formed on the magnetic thin film of the first magnetic field generator.

28. A method comprising:
providing a magnetic field generator having a surface, the magnetic field generator comprising a magnetic thin film in which there are two magnetic domains with a domain wall between the two magnetic domains, wherein a magnetic field is produced by the domain wall;
holding a sample sufficiently close to the surface of the magnetic field generator to be effected by the magnetic field produced by the domain wall;
detecting a response from the sample from the interaction of the magnetic field with the sample;
determining a parameter of the sample using the detected response; and
storing the determined parameter.

29. The method of claim 28, wherein the detected response is an electrical signal detected from the sample.

30. The method of claim 29, wherein the detected signal is at least one of a voltage signal and an inductance signal.

31. The method of claim 28, wherein the magnetic thin film comprises ferrimagnetic garnet.

32. The method of claim 31, wherein the ferrimagnetic garnet has a perpendicular anisotropy between 4000 Oe to 8000 Oe and a saturation magnetization 4πMₛ that is no less than 255 Oe.

33. The method of claim 31, wherein the ferrimagnetic garnet is polycrystalline or monocrystalline.

34. The method of claim 28, wherein the sample is a read/write head.

35. The method of claim 34, the method further comprising:
adjusting the Dynamic-Flying-Height of at least one of a write head and a read sensor in the sample;
detecting a response from the sample from the interaction of the magnetic field with the sample at each Dynamic-Flying-Height; and
wherein determining a parameter uses the detected responses at each Dynamic-Flying-Height.

36. The method of claim 28, further comprising:
moving the position of the magnetic field with respect to the sample;
detecting a response from the sample from the interaction of the magnetic field with the sample at each position; and
wherein determining a parameter uses the detected responses at each position.

37. The method of claim 36, wherein the sample is a read/write head, the method further comprising microactuating the read/write head to change the position of at least one of a read sensor and a write head with respect to the magnetic field without moving an air bearing surface of the read/write head with respect to the magnetic thin film.

38. The method of claim 36, further comprising: microactuating a suspension coupled to the sample to change the position of the sample with respect to the magnetic thin film to move the position of the magnetic field with respect to the sample.

39. The method of claim 36, wherein the parameter comprises at least one of a spatial response function, a dimension of the sample, a spatial dispersion of the ferromagnetic resonance of the sample, and a repeatability function that measures performance stability of the sample.

40. The method of claim 36, wherein moving the position of the domain wall comprises applying an external magnetic field to the magnetic field generator.

41. The method of claim 28, wherein the parameter comprises at least one of spatially resolved ferromagnetic resonance of the sample, and nuclear magnetic resonance of the sample.

42. The method of claim 28, further comprising varying the temperature of the magnetic field generator and detecting signals from the sample when the magnetic field generator is at the varied temperature.

43. The method of claim 28, further comprising varying the temperature of the sample and detecting signals from the sample at the varied temperature.

44. The method of claim 28, further comprising oscillating the domain wall and wherein detecting the response comprises detecting a signal from the sample from the interaction of the oscillating magnetic field with the sample.

45. The method of claim 44, further comprising:
moving the position of the magnetic field with respect to the sample and oscillating the domain wall at each new position;
detecting a signal from the sample from the interaction of the oscillating magnetic field with the sample at each position; and
wherein determining a parameter uses the detected signals at each position.

46. The method of claim 44, wherein oscillating the domain wall comprises modulating the oscillation of the domain wall.

47. The method of claim 46, wherein the modulation of the oscillation of the domain wall has a frequency and wherein the detected signal is detected and amplified by locking onto the frequency of the modulation.

48. The method of claim 44, wherein the oscillating domain wall produces voltage signals in the sample that are detected.

49. The method of claim 48, wherein the sample is a write head.

50. A method of producing parallel domain walls in a ferrimagnetic garnet film, the method comprising:
applying an in-plane magnetic field to the ferrimagnetic garnet film;
applying a perpendicular magnetic field thereby saturating the ferrimagnetic garnet film;
reducing the perpendicular magnetic field until magnetic domains in the ferrimagnetic garnet film nucleate and produce parallel domain walls between the magnetic domains.

51. The method of claim 50, further comprising reducing the in-plane magnetic field and further reducing the perpendicular magnetic field thereby extending the length of the parallel domain walls.

52. The method of claim 51, further comprising removing the in-plane magnetic field.

53. The method of claim 50, wherein the applied in-plane magnetic field is not less than 200 Oe.

54. The method of claim 50, wherein the applied perpendicular magnetic field is not less than 140 Oe.

55. The method of claim 51, wherein the perpendicular magnetic field is further reduced to not less than 40 Oe.

56. The method of claim 50, wherein the ferrimagnetic garnet film has an additional axis of easy magnetization in the film plane.

57. A method comprising:
providing a magnetic field generator having a surface, the magnetic field generator comprising a magnetic thin film in which there are two magnetic domains with a domain wall between the two magnetic domains, wherein a magnetic field is produced by the domain wall;
holding a sample sufficiently close to the surface of the magnetic field generator to be effected by the magnetic field produced by the domain wall;
microactuating the sample to change the position of at least a portion of the sample with respect to the surface of the magnetic field generator;
detecting signals from the sample in response to the magnetic field;
determining a parameter of the sample using the detected signals; and
storing the determined parameter.

58. The method of claim 57, wherein the domain wall has a width, and wherein the sample is held approximately the width of the domain wall or less from the surface of the magnetic field generator.

59. The method of claim 57, wherein the parameter of the sample comprises at least one of verification of the performance and qualification of a microactuator that microactuates the sample.

60. The method of claim 57, wherein the magnetic thin film comprises ferrimagnetic garnet.

61. The method of claim 60, wherein the ferrimagnetic garnet has a perpendicular anisotropy between 4000 Oe to 8000 Oe and a saturation magnetization 4πMₛ that is no less than 255 Oe.

62. The method of claim 60, wherein the ferrimagnetic garnet is polycrystalline or monocrystalline.

63. The method of claim 57, wherein the sample is a read/write head and wherein microactuating the sample comprises changing the position of at least one of a read sensor and a write head in the read/write head with respect to the surface of the magnetic field generator without moving an air bearing surface of the read/write head with respect to the magnetic thin film.

64. The method of claim 57, wherein microactuating the sample comprises microactuating a suspension coupled to the sample to change the position of the sample with respect to the surface of the surface of the magnetic field generator.

65. A method comprising:
providing a magnetic field generator having a surface, the magnetic field generator comprising a magnetic thin film in which there are two magnetic domains with a domain wall between the two magnetic domains, wherein a magnetic field is produced by the domain wall;
holding a sample sufficiently close to the surface of the magnetic field generator to be effected by the magnetic field produced by the domain wall;
moving the domain wall to change the position of the magnetic field with respect to the sample;
magneto-optically imaging the domain wall in different positions;
monitoring the location of distortions in the magneto-optically imaged domain wall to characterize structures in the sample; and
storing the characterization of the structures.

66. The method of claim 65, wherein the characterization of the structures is the location of defects in the sample.

67. The method of claim 65, wherein the characterization of the structures is the identification of the shape of the structures.

68. The method of claim 65, wherein the domain wall is moved with an AC field.

69. The method of claim 65, wherein the domain wall is moved with a DC field.

70. The method of claim 65, wherein magneto-optical imaging the domain wall is performed using at least one of Faraday and Kerr domain imaging.

71. The method of claim 65, wherein the magnetic thin film comprises ferrimagnetic garnet.

72. The method of claim 71, wherein the ferrimagnetic garnet has a perpendicular anisotropy between 4000 Oe to 8000 Oe and a saturation magnetization 4πMₛ that is no less than 255 Oe.

73. The method of claim 71, wherein the ferrimagnetic garnet is polycrystalline or monocrystalline.
